(19) United States
(12) Patent Application Publication
(10) Pub. No.: US 2021/0365988 A1
(43) Pub. Date: Nov. 25, 2021

(54) MOBILE MARKETING COMMUNICATION SYSTEMS AND METHODS

(71) Applicant: Aaron Joseph Brooks, Dallas, TX (US)

(72) Inventor: Aaron Joseph Brooks, Dallas, TX (US)

(21) Appl. No.: 16/879,124

(22) Filed: May 20, 2020

(51) Int. Cl. G06Q 30/02

(52) U.S. Cl. CPC G06Q 30/0265

(57) ABSTRACT

A system to enable mobile marketing communication that includes a vehicular window coupled to a vehicle, an electronic display positioned adjacent to the vehicular window, and an information store that includes adverts. A vehicular state sensor is positioned proximate to the vehicular window and configured to detect driving events associated with the vehicle. A control circuit is communicatively coupled to the electronic display, the information store, and the vehicular state sensor. The control circuit is configured to determine, via the vehicular state sensor, the driving events. The control circuit is further configured to convey, via the electronic display, an advert when the driving event is a left turn, a right turn, a reversing state, or a parked state. The vehicular state sensor include lateral and longitudinal accelerometers that detect the lateral and longitudinal acceleration of the vehicle.

### FIELD OF THE INVENTION

The present disclosure relates generally to marketing communication systems. More specifically, the present disclosure describes mobile marketing communication systems and methods.

### BACKGROUND OF THE INVENTION

Advertising is a marketing communication that employs an openly sponsored, non-personal message to promote or sell a product, service or idea. Sponsors of advertising are typically businesses wishing to promote their products or services. Advertising is differentiated from public relations in that an advertiser pays for and has control over the message. It differs from personal selling in that the message is non-personal, i.e., not directed to a particular individual. Advertising is communicated through various mass media, including traditional media such as newspapers, magazines, television, radio, outdoor advertising or direct mail; and new media such as search results, blogs, social media, websites or text messages. The actual presentation of the message in a medium is referred to as an advertisement, or “ad” or advert for short.

Out-of-home media advertising is focused on marketing to consumers when they are “on the go” in public places, in transit, waiting (such as in a medical office), and/or in specific commercial locations (such as in a retail venue). OOH advertising formats typically fall into six main categories: billboards, street, roads, highways, transit, and alternative.

### BRIEF DESCRIPTION OF THE DRAWINGS

Some of the embodiments will be described in detail, with reference to the following figures, wherein like designations denote like members, wherein:

FIG. 1 depicts a block diagram of a mobile marketing communication system positioned within a vehicle according to some embodiments.

FIG. 2 depicts a top view of vehicular windows of the vehicle and a threshold distance according to other embodiments.

FIG. 3 depicts an abstract model of the vehicle following a driving path and associated vehicular events according to certain embodiments.

FIG. 4 illustrates process steps for a method to enable mobile marketing communication according to yet still other embodiments.

FIG. 5 illustrates process steps for a method to enable mobile marketing communication according to some embodiments.

FIG. 6 illustrates process steps for a method to enable mobile marketing communication according to certain embodiments.

FIG. 7 depicts a block diagram of a computer device according to other embodiments.

Unless otherwise specifically noted, articles depicted in the drawings are not necessarily drawn to scale.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

The present disclosure includes many aspects and features. Moreover, while many aspects and features relate to, and are described in the context of mobile marketing communication systems and methods, embodiments of the present disclosure are not limited to use only in this context.

Advertising is a marketing communication that employs an openly sponsored, non-personal message to promote or sell a product, service or idea. Sponsors of advertising are typically businesses wishing to promote their products or services. Advertising is differentiated from public relations in that an advertiser pays for and has control over the message. It differs from personal selling in that the message is non-personal, i.e., not directed to a particular individual. Advertising is communicated through various mass media, including traditional media such as newspapers, magazines, television, radio, outdoor advertising or direct mail; and new media such as search results, blogs, social media, websites or text messages. The actual presentation of the message in a medium is referred to as an advertisement, or “ad” or advert for short.

Out-of-home (“OOH”) media advertising is focused on marketing to consumers when they are “on the go” in public places, in transit, waiting (such as in a medical office), and/or in specific commercial locations (such as in a retail venue). OOH advertising formats typically fall into six main categories: billboards, street, roads, highways, transit, and alternative.

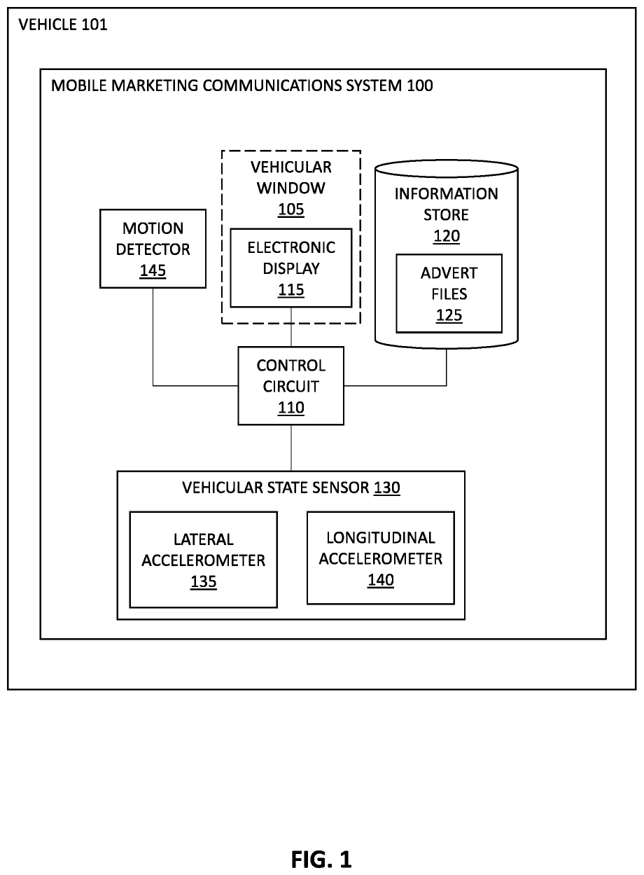

FIG. 1 depicts a block diagram of a mobile marketing communication system (“MMCS”), generally 100, positioned within a vehicle 101 according to some embodiments. The vehicle 101 can be any terrestrial vehicle that includes at least one window (e.g., trucks, buses, vans, cars, etc.). The MMCS 100 preferably includes at least one vehicular window 105 (coupled to the vehicle 101), an electronic display(s) 115, an information store(s) 120, a vehicular state sensor(s) 130, a motion sensor(s) 145 each communicatively coupled to the control circuit(s) 110. The control circuit(s) 110 can perform one or more of the steps, processes, functions disclosed herein. The vehicular window 105 can be a front, side, or rear window. In general, the vehicular window 105 can be any type or shape of window that can receive and allow viewing of the electronic display 115 by persons positioned external to the vehicle 101. The vehicular window 105 can be made of glass and/or polymer(s). The electronic display 115 is positioned adjacent to the vehicular window 105.

In preferred embodiments, the vehicular window 105 incorporates the electronic display 115 as a single unit or as separate components that are subsequently assembled together. In other words, the vehicular window 105 can be manufactured to include the electronic display 115.

The electronic display 115 is a transparent (e.g., OLED, microLED, etc.) electronic display device. The electronic display 115 is preferably an electronic display that allows the user to see what is shown on the glass screen while still being able to see through it. When affixed to the vehicular window 105, the electronic display 115 is used to display information (e.g., adverts) to persons external to the vehicle 101 (e.g., pedestrians). The information store 120 is a data storage repository that includes advert files 125. The advert files 125 preferably include marketing communication (advertising) that employs an openly sponsored non-personal message that promotes or sells a product, service or idea. The information store 120 can include databases (e.g., relational databases, object-oriented databases, etc.), file systems, distributed data stores, as well as similar storage systems.

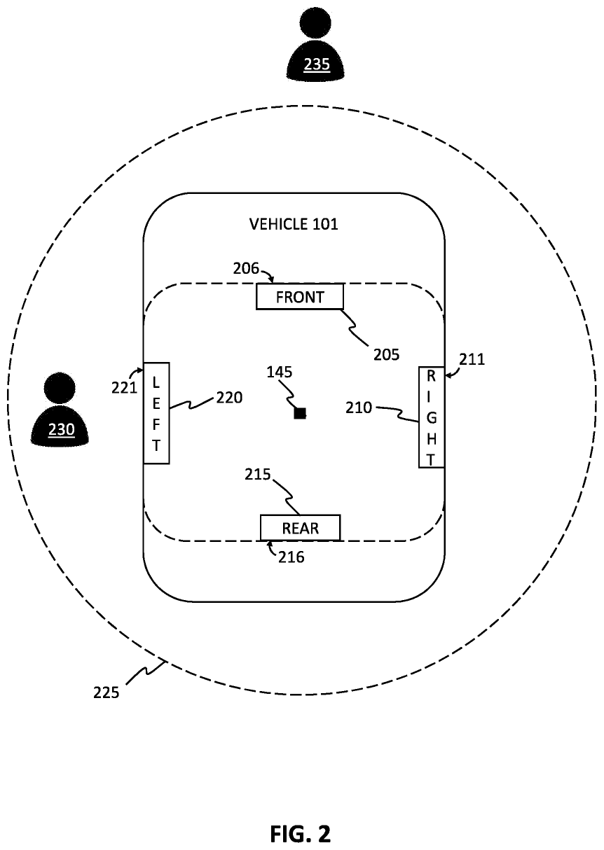

FIG. 2 depicts a top view of vehicular windows of the vehicle and a threshold distance according to other embodiments. The vehicle 101 can have one or more vehicular windows 105 (e.g., front vehicular window 205, right vehicular window 210, rear vehicular window 215, and left vehicular window 220). To be sure, front vehicular window 205, right vehicular window 210, rear vehicular window 215, and left vehicular window 220 each include a vehicular window 105 as well as an electronic display 115. The front vehicular window 205, right vehicular window 210, rear vehicular window 215, and left vehicular window 220 are oriented towards the front, right, rear, and left sides of the vehicle 101, respectively. The motion sensor 145 is a device that is preferably positioned proximate to the vehicular window 105 and is configured to determine the presence of humans (e.g., person 230) within a threshold distance 225 of the vehicle 101, as opposed to their presence beyond the threshold distance 225. For example, the motion sensor 145 can use infrared, microwaves, ultrasonic waves, radio waves, video analysis, and similar methods to determine the presence of humans with the threshold distance 225. The threshold distance, for example, is the maximum distance at which pedestrians can view information conveyed via the electronic display 115

The vehicular state sensor 130 is preferably positioned proximate to the vehicular window 105 and configured to detect driving events associated with the vehicle 101. The system 100 uses the detected driving events to determine when to convey adverts (e.g., the advert files 125) via the electronic display 114. Applicable driving events, include but are not limited to, left turn, right turn, a reversing state, and a parked state. As used herein, “driving events” refer to vehicular states that are advantageous to convey adverts in. The vehicular state sensor 130 is a device that determines driving events by quantifying lateral and longitudinal acceleration along two fixed axis (e.g., x and y).

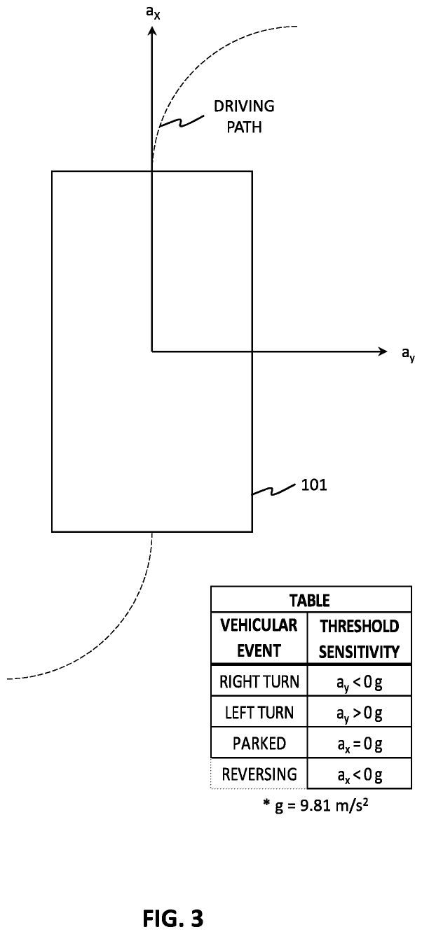

FIG. 3 depicts an abstract model of the vehicle 101 following a driving path and associated vehicular events according to certain embodiments. In the plane of vehicle movement, let the vehicle-fixed x-axis be tangential to the path of the vehicle 101 at any point in time, and the y-axis perpendicular. Then, three distinct maneuvers can be detached by thresholds on these measurements. As reflected in the Table, along the y-axis, lateral acceleration reflects left (a_{y}>0 g) or right (a_{y}<0 g) turns and, along the x-axis, longitudinal acceleration reflects forward (aₓ>0 g) and reversing (aₓ<0 g) states. Similarly, when the vehicle 101 is stationary (e.g., in a parked or stationary state) there is no acceleration along the x-axis (e.g., aₓ=0 g). As used herein, “g” refers to gravity and has a value of 9.81 m/s².

The vehicular state sensor 130 preferably includes a lateral accelerometer 135 and a longitudinal accelerometer 140. The lateral accelerometer is configured to determine lateral the acceleration of the vehicle 101. The vehicular state sensor 130 is configured to detect, using the lateral accelerometer 135, left turns when the lateral acceleration is positive and right turns when the lateral acceleration is negative. The vehicular state sensor 130 is further configured to determine longitudinal accelerations of the vehicle 101. According to preferred embodiments, the vehicular state sensor 130 is configured to detect, using the longitudinal accelerometer 135, parked states when the longitudinal acceleration is zero for a predetermined time period (e.g., to differentiate between parking and abrupt braking).

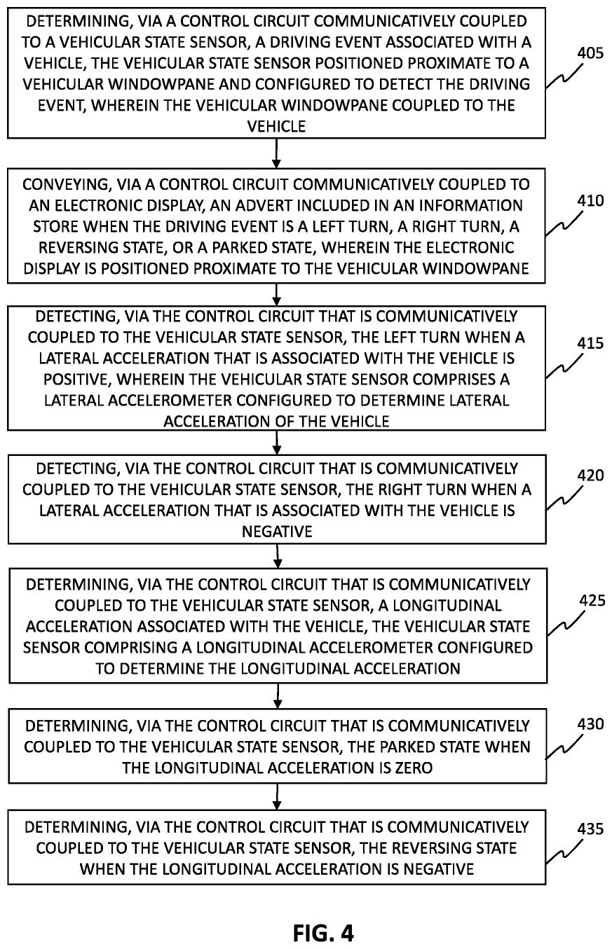

FIG. 4 illustrates process steps for a method to enable mobile marketing communication according to yet still other embodiments. To begin, a driving event associated with a vehicle (e.g., the vehicle 101) is determined using the vehicular state sensor 130 (Step 405). Here, the vehicular state sensor 130 is positioned proximate to a vehicular window 105 that is coupled to the vehicle 101 and configured to detect the driving event. At Step 410, an advert (e.g., included in the advert files 125) included in an information store 120 is conveyed via an electronic display 115 when the driving event is determined to be a left turn, a right turn, a reversing state, or a parked state. Here, as discussed above, the electronic display 115 is positioned adjacent to the vehicular window 105.

At Step 415, the left turn is detected via the vehicular state sensor when a lateral acceleration that is associated with the vehicle is positive (a_{y}>0 g). Here, the vehicular state sensor 130 includes a lateral accelerometer 135 that is configured to determine lateral acceleration of the vehicle 101. At Step 420, the right turn is detected via the vehicular state sensor 130 when lateral acceleration of the vehicle 101 is negative (a_{y}<0 g). At Step 425, longitudinal acceleration of the vehicle 101 is determined using the vehicular state sensor 130. In this instance, the vehicular state sensor 130 includes a longitudinal accelerometer 140 that is configured to determine the longitudinal acceleration reading. At Step 430, the parked state is determined using the vehicular state sensor 130 when longitudinal acceleration is zero (aₓ=0 g). At Step 435, the reversing state is determined using the vehicular state sensor 130 when the longitudinal acceleration is negative (aₓ<0 g).

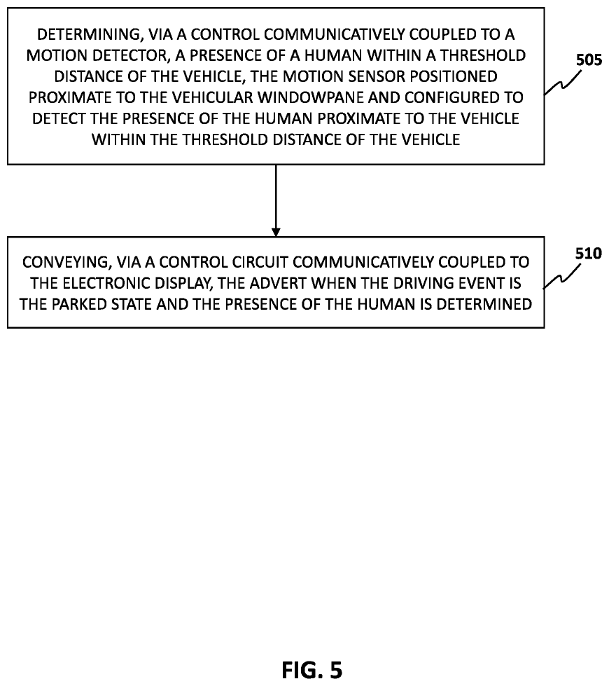

FIG. 5 illustrates process steps for a method to enable mobile marketing communication according to some embodiments. In certain embodiments, to convey the advert (Step 410), a presence of a human (e.g., person 230) within a threshold distance 225 of the vehicle 101 is determined using a motion sensor 145 (Step 505). Here, the motion sensor 145 is preferably positioned proximate to the vehicular window 105 and configured to detect the presence of the human (person 230) that is positioned proximate to the vehicle 101 within the threshold distance 225 of the vehicle 101. To be sure, the motion sensor 145 fails to detect the presence of person 235 because they are positioned outside the threshold distance 225. At Step 510, the advert is conveyed using the electronic display 115 when the driving event is the parked state and the presence of the human is determined.

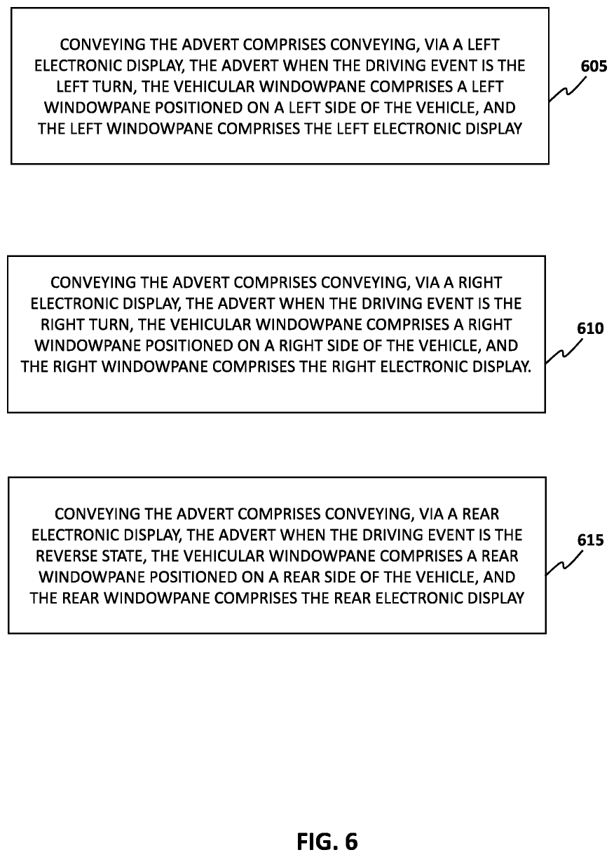

FIG. 6 illustrates process steps for a method to enable mobile marketing communication according to some embodiments. In other embodiments, Step 410 can be accomplished in alternative manners. Referring now to FIG. 2. For example, at Step 605, the advert is conveyed using a left electronic display 221 when the driving event is the left turn. Here, the vehicular window 105 includes the left vehicular window 220. The left vehicular window 220 includes the left electronic display 221 and both are positioned on the left side of the vehicle 101. In another example, at Step 610, the advert is conveyed using a right electronic display 211 when the driving event is the right turn. Here, the vehicular window 105 includes the right vehicular window 210. The right vehicular window 210 includes the right electronic display 211 and both are positioned on the right side of the vehicle 101. In an alternative example, at Step 615, the advert is conveyed using a rear electronic display 216 when the driving event is the reverse state. Here, the vehicular window 105 includes the rear vehicular window 215. The rear vehicular window 215 includes the rear electronic display 216 and both are positioned on the rear side of the vehicle 101.

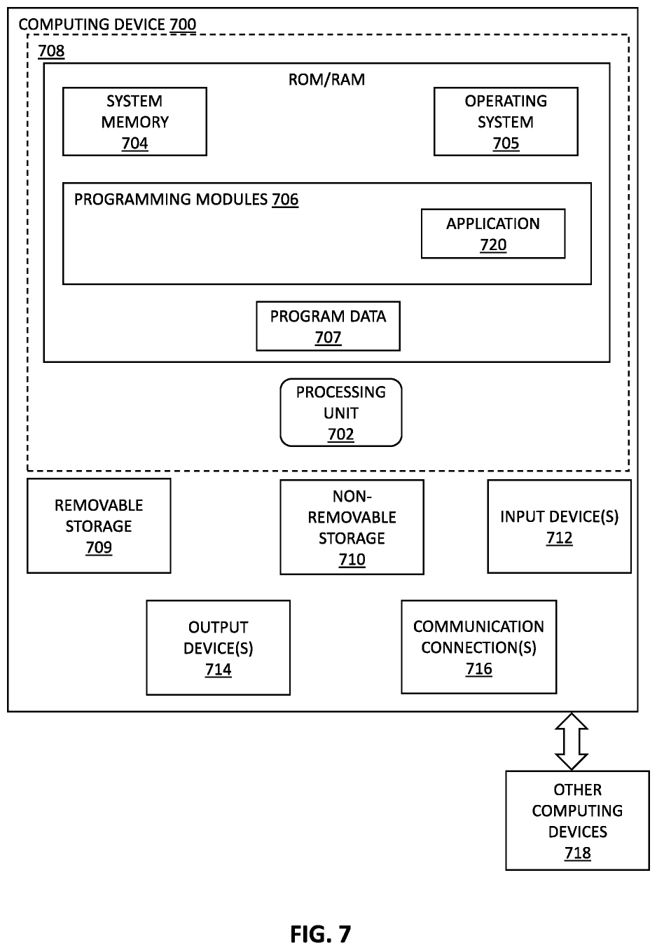

With reference to FIG. 7, a system consistent with an embodiment of the disclosure may include a computing device or cloud service, such as computing device 700. Computing device 700 can represent MMCS 100. In a basic configuration, computing device 700 may include at least one processing unit 702 (e.g., control circuit 110) and a system memory 704. Depending on the configuration and type of computing device, system memory 704 may comprise, but is not limited to, volatile (e.g. random-access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling computing device 700's operation. In one embodiment, programming modules 706 may include machine learning module. Furthermore, embodiments of the disclosure may be practiced in conjunction with a graphics library, other operating systems, or any other application program and is not limited to any particular application or system. This basic configuration is illustrated in FIG. 7 by those components within a dashed line 708.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable and non-removable media implemented in any method or technology for storage of information, such as computer-readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 712 such as a keyboard, a mouse, a pen, a sound input device, a touch input device, a location sensor, a camera, a biometric sensor, etc. Output device(s) 714 such as a display, speakers, a printer, etc. may also be included. The aforementioned devices are examples and others may be used.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 704, including operating system 705. While executing on processing unit 702 (e.g., control circuit 110), programming modules 706 (e.g., application 720 such as a media player) may perform processes including, for example, one or more stages of methods, algorithms, systems, applications, servers, databases as described above. The aforementioned process is an example, and processing unit 702 (e.g., control circuit 712) may perform other processes. Other programming modules that may be used in accordance with embodiments of the present disclosure may include machine learning application.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communication network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the disclosure has been explained in relation to its preferred embodiment, it is to be understood that many other possible modifications and variations can be made without departing from the spirit and scope of the disclosure.

What is claimed is:

1. A system to enable mobile marketing communication, comprising:
a vehicular window coupled to a vehicle;
an electronic display positioned adjacent to the vehicular window;
an information store comprising an advert;
a vehicular state sensor positioned proximate to the vehicular window and configured to detect a driving event associated with the vehicle;
a control circuit communicatively coupled to the electronic display, the information store, the vehicular state sensor;
wherein the control circuit is configured to:
determine, via the vehicular state sensor, the driving event; and
convey, via the electronic display, the advert when the driving event is a left turn, a right turn, a reversing state, or a parked state.

2. The system of claim 1, wherein
the vehicular state sensor comprises:
a lateral accelerometer configured to determine lateral acceleration of the vehicle;
wherein the vehicular state sensor is configured to
detect, using the lateral accelerometer, the left turn when the lateral acceleration is positive; and
detect, using the later accelerometer, the right turn when the lateral acceleration is negative.

3. The system of claim 2, wherein
the vehicular state sensor comprises:
a longitudinal accelerometer configured to determine a longitudinal acceleration of the vehicle; and
wherein the vehicular state sensor is configured to detect, using the longitudinal accelerometer, the parked state when the longitudinal acceleration is zero for a predetermined time period.

4. The system of claim 3, wherein the vehicular state sensor is configured to determine, using the longitudinal accelerometer, the reversing state when the longitudinal acceleration is negative.

5. The system of claim 4, further comprising:
a motion sensor positioned proximate to the vehicular window and configured to detect a presence of a human within a threshold distance of the vehicle;
wherein in conveying the advert the control circuit is configured to:
determine, using the motion detector, the presence of the human; and
convey, via the electronic display, the advert when the driving event is the parked state and the presence of the human is determined.

6. The system of claim 5, wherein
the vehicular window pane comprises a left window positioned on a left side of the vehicle;
the left window pane comprises a left electronic display positioned adjacent to the left window pane; and
in conveying the advert, the control circuit is configured to convey, using the left electronic display, the advert when the driving event is the left turn.

7. The system of claim 6, wherein
the vehicular window pane comprises a right window pane positioned on a right side of the vehicle;
the vehicular window pane comprises a right electronic display positioned adjacent to the right window pane; and
in conveying the advert, the control circuit is configured to convey, using the right electronic display, the advert when the driving event is the right turn.

8. The system of claim 7, wherein
the vehicular window pane comprises a rear window pane positioned on a rear side of the vehicle;
the vehicular window pane comprises a rear electronic display positioned adjacent to the rear window pane; and
conveying the advert when the driving event is the reversing state comprises conveying, using the rear electronic, the advert when the driving event is the reversing state.

9. A method to enable mobile marketing communication, comprising:
determining, via a control circuit communicatively coupled to a vehicular state sensor, a driving event associated with a vehicle, the vehicular state sensor positioned proximate to a vehicular window pane and configured to detect the driving event, wherein the vehicular window pane coupled to the vehicle; and
conveying, via a control circuit communicatively coupled to an electronic display, an advert included in an information store when the driving event is a left turn, a right turn, a reversing state, or a parked state, wherein the electronic display is positioned adjacent to the vehicular window pane.

10. The method of claim 9, further comprising:
detecting, via the control circuit that is communicatively coupled to the vehicular state sensor, the left turn when a lateral acceleration that is associated with the vehicle is positive, wherein the vehicular state sensor comprises a lateral accelerometer configured to determine lateral acceleration of the vehicle; and
detecting, via the control circuit that is communicatively coupled to the vehicular state sensor, the right turn when a lateral acceleration that is associated with the vehicle is negative.

11. The method of claim 10, further comprising:
determining, via the control circuit that is communicatively coupled to the vehicular state sensor, a longitudinal acceleration associated with the vehicle, the vehicular state sensor comprising a longitudinal accelerometer configured to determine the longitudinal acceleration; and
determining, via the control circuit that is communicatively coupled to the vehicular state sensor, the parked state when the longitudinal acceleration is zero.

12. The method of claim 11, further comprising:
determining, via the control circuit that is communicatively coupled to the vehicular state sensor, the reversing state when the longitudinal acceleration is negative.

13. The method of claim 12, wherein conveying the advert further comprises:
determining, via a control communicatively coupled to a motion detector, a presence of a human within a threshold distance of the vehicle, the motion sensor positioned proximate to the vehicular window pane and configured to detect the presence of the human proximate to the vehicle within the threshold distance of the vehicle; and
conveying, via a control circuit communicatively coupled to the electronic display, the advert when the driving event is the parked state and the presence of the human is determined.

14. The method of claim 13, wherein
conveying the advert comprises conveying, via a left electronic display, the advert when the driving event is the left turn;
the vehicular window pane comprises a left window pane positioned on a left side of the vehicle, and
the left window pane comprises the left electronic display.

15. The method of claim 14, wherein
conveying the advert comprises conveying, via a right electronic display, the advert when the driving event is the right turn;
the vehicular window pane comprises a right window pane positioned on a right side of the vehicle, and
the right window pane comprises the right electronic display.

16. The method of claim 15, wherein
conveying the advert comprises conveying, via a rear electronic display, the advert when the driving event is the reverse state;
the vehicular window pane comprises a rear window pane positioned on a rear side of the vehicle; and
the rear window pane comprises the rear electronic display.

17. A method to enable mobile marketing communication, comprising:
determining, via a control circuit communicatively coupled to a vehicular state sensor, a driving event associated with a vehicle, the vehicular state sensor positioned proximate to a vehicular window pane and configured to detect the driving event, wherein the vehicular window pane coupled to the vehicle;
conveying, via a control circuit communicatively coupled to an electronic display, an advert included in an information store when the driving event is a left turn, a right turn, a reversing state, or a parked state, wherein the electronic display is positioned adjacent to the vehicular window pane;
detecting, via the control circuit that is communicatively coupled to the vehicular state sensor, the left turn when a lateral acceleration that is associated with the vehicle is positive, wherein the vehicular state sensor comprises a lateral accelerometer configured to determine lateral acceleration of the vehicle;
detecting, via the control circuit that is communicatively coupled to the vehicular state sensor, the right turn when a lateral acceleration that is associated with the vehicle is negative;
determining, via the control circuit that is communicatively coupled to the vehicular state sensor, a longitudinal acceleration associated with the vehicle, the vehicular state sensor comprising a longitudinal accelerometer configured to determine the longitudinal acceleration; and
determining, via the control circuit that is communicatively coupled to the vehicular state sensor, the parked state when the longitudinal acceleration is zero.

18. The method of claim 17, wherein conveying the advert further comprises:
determining, via a control communicatively coupled to a motion detector, a presence of a human within a threshold distance of the vehicle, the motion sensor positioned proximate to the vehicular window pane and configured to detect the presence of the human proximate to the vehicle within the threshold distance of the vehicle; and
conveying, via a control circuit communicatively coupled to the electronic display, the advert when the driving event is the parked state and the presence of the human is determined.

19. The method of claim 18, wherein
conveying the advert comprises conveying, via a left electronic display, the advert when the driving event is the left turn, the vehicular window pane comprises a left window pane positioned on a left side of the vehicle, the left window pane comprises the left electronic display; and
conveying the advert comprises conveying, via a right electronic display, the advert when the driving event is the right turn, the vehicular window pane comprises a right window pane positioned on a right side of the vehicle, the right window pane comprises the left electronic display.

20. The method of claim 19, further comprising:
determining, via the control circuit that is communicatively coupled to the vehicular state sensor, the reversing state when the longitudinal acceleration is negative; and
conveying the advert comprises conveying, via a rear electronic display, the advert when the driving event is the reverse state, the vehicular window pane comprises a rear window pane positioned on a rear side of the vehicle, the rear window pane comprises the rear electronic display.
